(19) United States
(12) Patent Application Publication
(10) Pub. No.: US 2004/0079636 A1
(43) Pub. Date: Apr. 29, 2004

(54) Biomedical ion sensitive semiconductor sensor and sensor array

(76) Inventors: Chin Hsia, Taichung (TW); Chao-Sung Lai, Kwai Shan (TW); Chai-Ming Yang, Kwai Shan (TW); Wang-Ping Shih, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/279,796

(22) Filed: Oct. 25, 2002

(51) Int. Cl. G01N 27/26

(52) U.S. Cl. 204/403.01; 204/416

(57) ABSTRACT

A biomedical ion sensitive sensor for sensing an ion concentration of a biomedicine sample includes an insulation layer formed on a substrate having a source region and a drain region. A gate oxide layer formed on the surface of the source region, the drain region, and the insulation layer. A chemical membrane layer is formed on the gate oxide layer. A concave ion sensitive portion is formed at an area of the surface of the chemical membrane layer defined between the source region and the drain region, and a rough surface is further formed on the ion sensitive portion. The ion sensitive film is made of Si₃N₄, SiO₂, Al₂O₃, Ta₂O₅, SnO₂, ZrO₂, or HfO₂. A plurality of biomedical ion sensitive semiconductor sensors are communicated with reactant micro-fluid channels to form a biomedical ion sensitive semiconductor sensor array.

### BACKGROUND OF THE INVENTION

1. Field of the Invention

The present invention relates generally to a semiconductor sensor, and more particularly to a biomedical ion sensitive semiconductor sensor for measuring hydrogen ions of a biomedicine sample.

2. Description of the Prior Art

Recently, biomedicine has been developed and used to improve human life. Biomedicine has become an important issue in the world and is expected to play a leading role in the future. In most developed country, bio-industry and biomedicine are listed to be the first priority for development. In fact, biomedicine is a potential industry that can bring health and wealth to human.

In medical checkup and disease diagnosis, blood and urine are usually the first and basic diagnostic items. However, most of diagnoses have to be done in clinical centers or hospitals. There has been a demand for people that they can take diagnosis by themselves at home or by the doctors at small clinics, so that both patients and doctors can know well and monitor the patient's physiology. In this way, some diseases can be prevented or treated immediately. It not only saves a lot of money, but also shortens the treatment time. For example, the concentration of ions in human blood e.g. H⁺, Na⁺, or K⁺ should be kept within standard ranges. When the concentration of e.g. Na⁺ is too high or too low, it will cause edema to the patient. To monitor the blood ions, it is desired to have a sensor of small size that can provide rapid analysis to human blood.

Due to the high viscosity of human blood, most commercial sensors, that can effectively separate and detect specific ion in human blood, are large in size. Recently, the industry has started to use a high sensitive and compact element, ion sensitive field effect transistor (ISFET), in sensor for blood chemicals diagnosis. For example, a prior art U.S. Pat. No. 5,543,024, a glucose sensitive FET sensor is disclosed, which converts the glucose to D-gluconic acid by means of an enzyme immobilized membrane and then responds to hydrogen ions. However, the development of such sensor for detection of blood ions is still in the early developing stage.

### SUMMARY OF THE INVENTION

Consequently, a primary object of the present invention is to provide a biomedical ion sensitive semiconductor sensor that is compact in size and light in weight for carry.

Another object of the invention is to provide a biomedical ion sensitive sensor that can be miniaturized for diagnosis of tracing blood sample.

A further object of the invention is to provide a biomedical ion sensitive semiconductor sensor that has high input impedance and low output impedance, and thereby it can enhance signal/noise ratio.

A further object of the invention is to provide a biomedical ion sensitive semiconductor sensor that has high input impedance and low output impedance, and thereby it can enhance signal/noise ratio.

A further object of the invention is to provide a biomedical ion sensitive semiconductor sensor that has high input impedance and low output impedance, and thereby it can enhance signal/noise ratio.

A still further object of the invention is to provide a biomedical ion sensitive semiconductor sensor that has fast response and high degree of sensitivity.

A still further object of the invention is to provide a biomedical ion sensitive semiconductor sensor made by semiconductor manufacturing process of which is compatible with that of metal-oxide-semiconductor transistor. Hence, the ion sensitive semiconductor sensor is possible to be mass-production and the production cost thereof is low.

A still further object of the invention is to provide a biomedical ion sensitive semiconductor sensor that can be further incorporated with a specific enzyme membrane. The enzyme membrane enables the ion sensitive semiconductor sensor to precisely detect specific chemical or substance. Thereby, various biosensors can be provided for different uses in diagnosis.

A still further object of the invention is to provide a biomedical ion sensitive semiconductor sensor array including a plurality of biomedical ion sensitive semiconductor sensors communicated with a plurality of reactant micro-fluid channels to form a biomedical ion sensitive semiconductor sensors.

To achieve the above objects, in accordance with a preferred embodiment of the present invention, a compact biomedical ion sensitive semiconductor sensor is fabricated by semiconductor field-effect-transistor manufacturing processes, which includes an insulation layer formed on a substrate having a source region and a drain region. A gate oxide layer formed on the surface of the source region, the drain region, and the insulation layer. An ion sensitive film is formed onto the gate oxide layer, a concave ion sensitive portion is formed at an area of the surface of the ion sensitive film defined between the source region and the drain region, and a rough surface is further formed on the ion sensitive portion. In alternative, the ion sensitive film is made of Si₃N₄, SiO₂, Al₂O₃, Ta₂O₅, SnO₂, ZrO₂, or HfO₂.

In an alternative embodiment of the present invention, a plurality of biomedical ion sensitive semiconductor sensors are communicated with reactant micro-fluid channels with different dimension from each others to form a biomedical ion sensitive semiconductor sensor array. A control unit is further coupled to the biomedical ion sensitive semiconductor sensors for detecting and reading the signal generated from the biomedical ion sensitive semiconductor sensors.

### BRIEF DESCRIPTION OF THE DRAWINGS

The present invention will be apparent to those skilled in the art by reading the following description of a best mode of operation thereof, with reference to the attached drawings, in which:

FIG. 1 is a top plan view showing a biomedical ion sensitive semiconductor sensor in accordance with a preferred embodiment of the present invention;

FIG. 2 is a diagrammatic cross-sectional view taken along line 2-2 of FIG. 1;

FIG. 3 is a diagrammatic cross-sectional view taken along line 3-3 of FIG. 1;

FIG. 4 is a graph showing the relationship between the magnitude of the current I_{DS} flowing through the drain electrode to the source electrode of the biomedical ion sensitive semiconductor sensor and the magnitude of the gate voltage V_{G} at pH2, pH4, pH6, pH8 and pH10;

FIG. 5 is a graph showing the relationship between the magnitude of the gate voltage and pH value at a sensitivity of about 25 mV/pH; and

FIG. 6 is a schematic circuit diagram of a biomedical ion sensitive semiconductor sensor array constructed by a plurality of biomedical ion sensitive semiconductor sensors of the present invention.

### DETAILED DESCRIPTION OF THE PREFERRED EMBODIMENTS

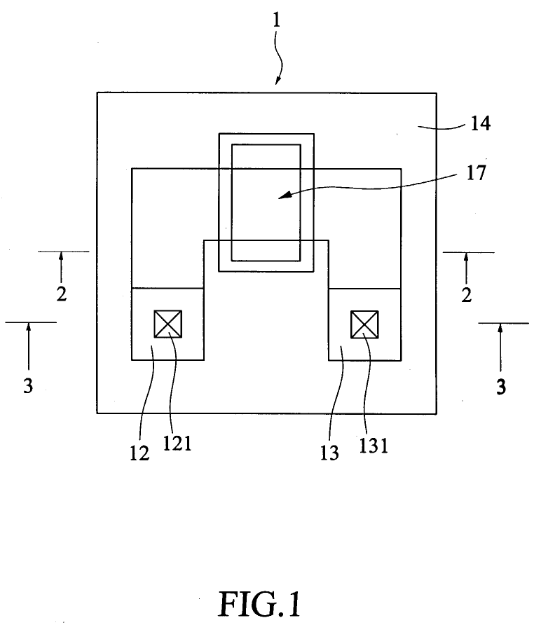

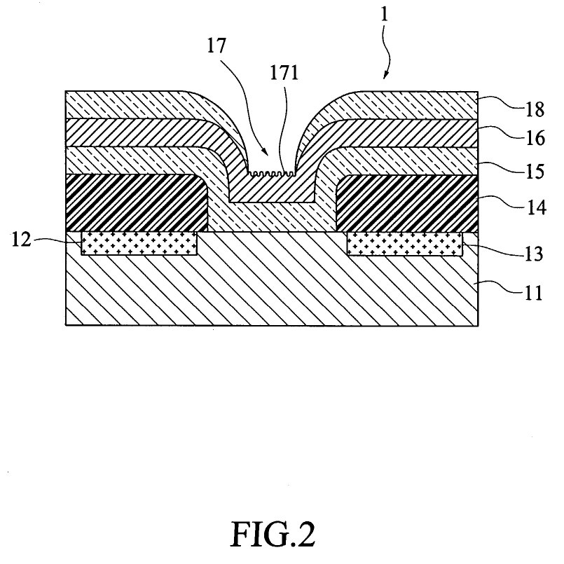

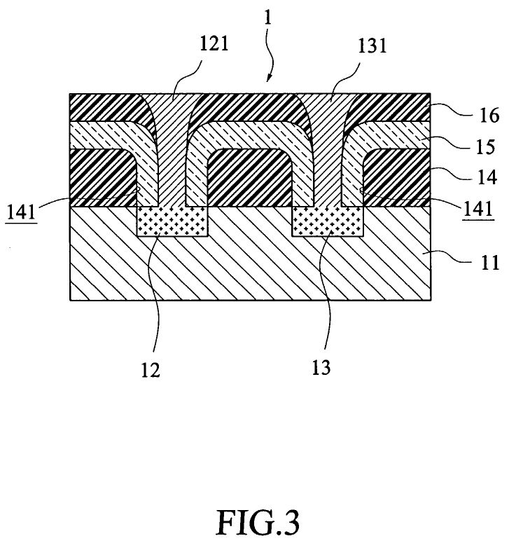

With reference to FIGS. 1 to 3, a biomedical ion sensitive semiconductor sensor constructed in accordance with a preferred embodiment of the present invention is shown. FIG. 1 is a top plan view showing the biomedical ion sensitive semiconductor sensor of the present invention. FIG. 2 is a diagrammatic cross-sectional view taken along line 2-2 of FIG. 1. FIG. 3 is a diagrammatic cross-sectional view taken along line 3-3 of FIG. 1. In accordance with the present invention, the biomedical ion sensitive semiconductor sensor, which is generally designated with reference numeral 1, includes a P-type semiconductor substrate 11.

A source region 12 and a drain region 13 are formed in the substrate 11 with a suitable distance therebetween. The source region 12 and the drain region 13 are implanted with suitable ions by using well-known implantation processes.

An insulation layer 14 made of silicon oxide (SiO₂) is formed on the substrate 11, leaving an opening portion with side walls 141 on the source region 12 and the drain region 13 respectively. The thickness of the insulation layer 14 is about 5000 Å. Thereafter, a gate oxide layer 15 is formed on the top surface of the insulation layer 14 and the side walls 141 of the insulation layer 14. The gate oxide layer 15 has a thickness about 1000 Å.

A replaceable chemical membrane layer 16 is further formed on the gate oxide layer 15, serving as a gate electrode of the ion sensitive semiconductor sensor of the present invention. The chemical membrane layer 16 may be selected from Si₃N₄ (Silicon Nitride), SiO₂ (Silicon Dioxide), Al₂O₃ (Aluminum Oxide), Ta₂O₅ (Tantalum Oxide), SnO₂ (Stannous Oxide), ZrO₂ (Zirconium Oxide), or HfO₂ (Hafnium Oxide). The gate oxide layer 15 and the chemical membrane layer 16 constitute in combination an ion sensitive film for the ion sensitive semiconductor sensor of the present invention. The chemical membrane layer 16 has a thickness about 1000 Å.

A concave ion sensitive portion 17 is thereby formed at an area of the top surface of the chemical membrane layer 16 defined between the source region 11 and the drain region 12. The effective area of the ion sensitive portion 17 is about 10-40 μm². The concave ion sensitive portion 17 is used to carry the biomedicine sample to be tested thereon.

Preferably, after the chemical membrane layer 16 is formed on the gate oxide layer 15, a known Reactive Ion Etching process which is widely used in semiconductor manufacturing processes is further conducted to the ion sensitive portion 17 of the chemical membrane layer 16, so that a surface-roughed silicon nitride film 171 having a regular or irregular concave-convex upper surface is formed thereon, with reference to FIG. 2. Due to the rough surface 171 of the ion sensitive portion 17 of the chemical membrane layer 16, a larger contact surface is obtained between the biomedicine sample to be tested and the ion sensitive portion 17.

A specific enzyme membrane (not shown) may be further formed on the ion sensitive portion 17 of the chemical membrane layer 16. The enzyme membrane enables the ion sensitive semiconductor sensor of the present invention to apply to detect specific chemical or substance. Thereby, various practical biosensors can be provided for different uses in diagnosis.

Furthermore, an epoxy layer 18 is formed on the chemical membrane layer 16, exposing the ion sensitive portion 17 of the chemical membrane layer 16. The epoxy layer 18 serves as an isolation material for the biomedicine sample to be tested.

With reference to FIG. 3, it shows that a source region plug conductor 121 is formed in the opening located on the source region 12 to electrically contact the source region 12. Similarly, a drain region plug conductor 131 is formed in the opening located on the drain region 13 to electrically contact the drain region 13. So, the electrical signals of the source region 12 and the drain region 13 can be sent to a signal receiving circuit or a controller (not shown). The source region plug conductor 121 and the drain region plug conductor 131 are made of aluminum.

The biomedical ion sensitive semiconductor sensor constructed in accordance with the present invention described above has the input impedance larger than 10²Ω and the output impedance in the range of about 100-1000²Ω. The biomedical ion sensitive semiconductor sensor of the present invention has advantages of high signal/noise ratio, fast response, and high degree of sensitivity. In wideband application area, when the ion concentration of the biomedicine sample to be tested is changed, the biomedical ion sensitive semiconductor sensor is able to convert the change of the ion concentration to corresponding electric signal, so that the biomedical ion sensitive semiconductor sensor is particularly applied to real-time detection.

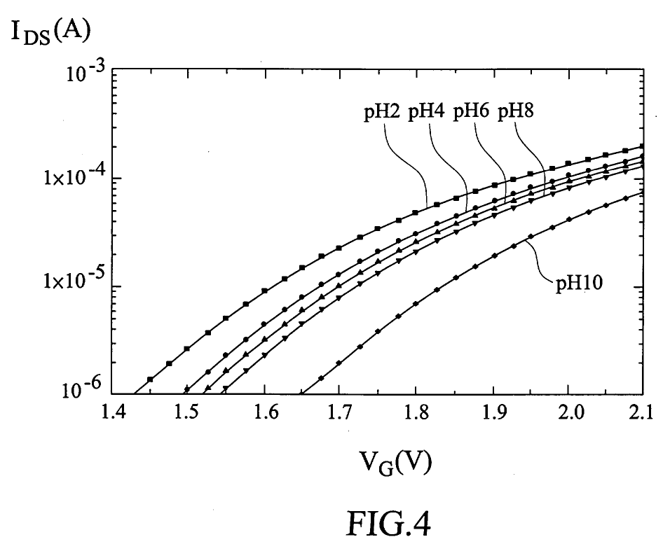

FIG. 4 is a graph showing the relationship between the magnitude of the current I_{DS} (A) flowing through the drain electrode to the source electrode of the biomedical ion sensitive semiconductor sensor and the magnitude of the gate voltage V_{G} (V) at pH2, pH4, pH6, pH8 and pH10, measured at 25° C. The vertical axis represents a current I_{DS} flowing through the drain electrode to the source electrode of the ion sensitive semiconductor sensor, and the horizontal axis represents a gate voltage V_{G} measured at the gate electrode of the biomedical ion sensitive semiconductor sensor.

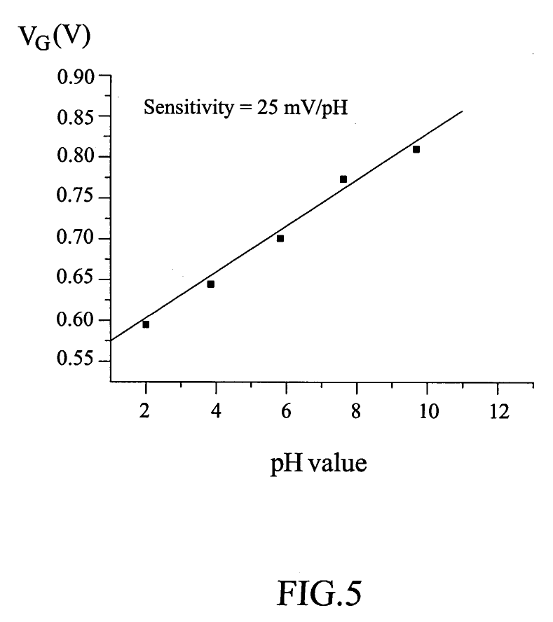

FIG. 5 is a graph showing the relationship between the magnitude of the gate voltage V_{DG} (V) and pH value at a sensitivity of about 25 mV/pH. The vertical axis represents a gate voltage V_{G} measured at the gate electrode of the ion sensitive semiconductor sensor, and the horizontal axis represents pH2 to pH10 values.

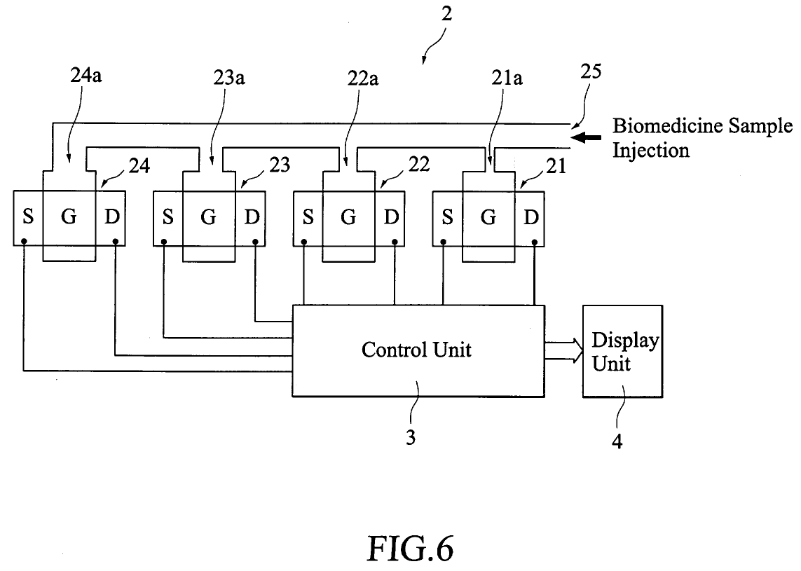

FIG. 6 is a schematic circuit diagram of a biomedical ion sensitive semiconductor sensor array constructed by a plurality of biomedical ion sensitive semiconductor sensors of the present invention. The ion sensitive semiconductor sensor array, generally designated with reference numeral 2, comprises a plurality of biomedical ion sensitive semiconductor sensor as described above.

In the exemplary embodiment as illustrated in FIG. 6, four biomedical ion sensitive semiconductor sensors 21, 22, 23, 24 are included in the ion sensitive semiconductor sensor array 2 for explanation. Each of the biomedical ion sensitive semiconductor sensors 21, 22, 23, 24 comprises a source electrode S, a drain electrode D, and a sensitive gate electrode G disposed between the source electrode S and the drain electrode D. The source electrode S and the drain electrode D of each biomedical ion sensitive semiconductor sensor are electrically connected to a control unit 3 used to detect and readout the output signals generated by the biomedical ion sensitive semiconductor sensors 21, 22, 23, and 24 respectively.

Furthermore, a number of reactant micro-fluid channels 21a, 22a, 23a, 24a with a common biomedicine sample injection inlet 25 are communicated with the surface of the sensitive gate electrode G of each biomedical ion sensitive semiconductor sensor 21, 22, 23, 24 respectively. In a preferred embodiment of the present invention, the reactant micro-fluid channels 21a, 22a, 23a, and 24a are dimension-selective reactant micro-fluid channels. That is, each reactant micro-fluid channel has different dimension from each others.

When a biomedicine sample is injected into the reactant micro-fluid channels 21a, 22a, 23a, and 24a though the biomedicine sample injection inlet 25, the various compounds or ions in the biomedicine sample are screened according to their dimensions by the reactant micro-fluid channels 21a, 22a, 23a, 24a, and then flow to the sensitive gate electrodes G of the biomedical ion sensitive semiconductor sensor 21, 22, 23, 24 for diagnosis.

Alternatively, the sensitive gate electrodes G of the biomedical ion sensitive semiconductor sensors 21, 22, 23, 24 can be made of different material in order to provide detection of various biomedical samples at various pH with optimal sensitivity.

The control unit 3 detects and reads the signals generated from the biomedical ion sensitive semiconductor sensors 21, 22, 23, and 24. After calculation and conversion, a set of data indicating the concentration of ions and relevant information of the biomedical sample may be further displayed on a display unit 4 for reading.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A biomedical ion sensitive semiconductor sensor for sensing an ion concentration of a biomedicine sample, comprising:
a substrate;
a source region formed in the substrate;
a drain region formed in the substrate;
an insulation layer formed on the substrate and leaving an opening portion with side walls on the source region and the drain region respectively;
a gate oxide layer formed on the insulation layer and the side walls of the insulation layer; and
a chemical membrane layer formed on the gate oxide layer, a concave ion sensitive portion being formed at a top surface of the chemical membrane layer defined between the source region and the drain region for carrying the biomedicine sample to be tested thereon, and a rough surface being further formed on the ion sensitive portion of the chemical membrane layer.

2. The biomedical ion sensitive semiconductor sensor as claimed in claim 1, wherein the insulation layer is made of silicon oxide.

3. The biomedical ion sensitive semiconductor sensor as claimed in claim 2, wherein the thickness of the insulation layer is about 5000 Å.

4. The biomedical ion sensitive semiconductor sensor as claimed in claim 1, wherein the thickness of the gate oxide layer is about 1000 Å.

5. The biomedical ion sensitive semiconductor sensor as claimed in claim 1, wherein the chemical membrane layer is selected from Si₃N₄, SiO₂, Al₂O₃, Ta₂O₅, SnO₂, ZrO₂, or HfO₂.

6. The biomedical ion sensitive semiconductor sensor as claimed in claim 5, wherein the thickness of the chemical membrane layer is about 1000 Å.

7. The biomedical ion sensitive semiconductor sensor as claimed in claim 1, wherein the ion sensitive portion is about 100-800 μm².

8. A biomedical ion sensitive semiconductor sensor array for sensing an ion concentration of a biomedicine sample, comprising:
a plurality of biomedical ion sensitive semiconductor sensors, each of which comprising a sensitive gate, for generating at least one signal representing the ion concentration of the biomedicine sample;
a plurality of reactant micro-fluid channels communicating with each sensitive gate of the biomedical ion sensitive semiconductor sensor respectively for supplying the biomedicine sample to the sensitive gates of the biomedical ion sensitive semiconductor sensors; and
a control unit coupled to the biomedical ion sensitive semiconductor sensors for detecting and reading the signal generated from the biomedical ion sensitive semiconductor sensors.

9. The biomedical ion sensitive semiconductor sensor array as claimed in claim 8, wherein each biomedical ion sensitive semiconductor sensor comprises:
a substrate;
a source region formed in the substrate;
a drain region formed in the substrate;
an insulation layer formed on the substrate and leaving an opening portion with side walls on the source region and the drain region respectively;
a gate oxide layer formed on the insulation layer and the side walls of the insulation layer; and
a chemical membrane layer formed on the gate oxide layer, a concave ion sensitive portion being formed at a top surface of the chemical membrane layer defined between the source region and the drain region for carrying the biomedicine sample to be tested thereon, and a rough surface being further formed on the ion sensitive portion of the chemical membrane layer.

10. The biomedical ion sensitive semiconductor sensor as claimed in claim 9, wherein the insulation layer is made of silicon oxide.

11. The biomedical ion sensitive semiconductor sensor as claimed in claim 9, wherein the chemical membrane layer is selected from Si₃N₄, SiO₂, Al₂O₃, Ta₂O₅, SnO₂, ZrO₂, or HfO₂.

12. The biomedical ion sensitive semiconductor sensor array as claimed in claim 8, wherein each of the reactant micro-fluid channels has a different dimension from each others.

13. The biomedical ion sensitive semiconductor sensor array as claimed in claim 8, further comprising a display unit connected to the control unit.
